(19) United States
(12) Patent Application Publication
(10) Pub. No.: US 2014/0076429 A1
(43) Pub. Date: Mar. 20, 2014

(54) Pump Apparatus

(71) Applicant: HITACHI AUTOMOTIVE SYSTEMS, LTD., HITACHINAKA-SHI (JP)

(72) Inventors: YOHEI MASUI, NAGOYA-SHI (JP); HIDEAKI TAKAHASHI, ATSUGI-SHI (JP); YOSHIKI SAKAMOTO, HITACHI-SHI (JP); TADAHARU YOKOTA, ATSUGI-SHI (JP)

(73) Assignee: HITACHI AUTOMOTIVE SYSTEMS, LTD., HITACHINAKA-SHI (JP)

(21) Appl. No.: 14/016,476

(22) Filed: Sep. 3, 2013

(30) Foreign Application Priority Data
Sep. 18, 2012 (JP) 2012-203811

(51) Int. Cl. F16K 15/02

(52) U.S. Cl. CPC F16K 15/025
USPC 137/535

(57) ABSTRACT

A pump apparatus including a discharge valve including a case member, a valve body within the case member, a seat member having a concaved valve seat, a retainer serving to retain the valve body on the valve seat on a side of one end of the retainer, an elastic member disposed on a side of the other end of the retainer, the elastic member serving to apply a biasing force to the valve body toward the seat member, and a guide portion formed on the retainer, the guide portion serving to guide the retainer relative to the case member when the valve body is moved to an open position, the guide portion being disposed on a radial outside of the elastic member or a radial inside thereof and overlapped with the elastic member in an axial direction thereof.

### BACKGROUND OF THE INVENTION

The present invention relates to a pump apparatus equipped with a discharge valve.

Japanese Patent Application Unexamined Publication No. 2002-195429 A discloses a pump apparatus equipped with a discharge valve in which a spring and a transfer member applying a biasing force of the spring to a valve body are disposed in series in an axial direction of the discharge valve such that a desired pressing force is applied to the valve body.

### SUMMARY OF THE INVENTION

However, the above-described conventional art has a problem that a size of the discharge valve in the axial direction is increased due to the arrangement in which the valve body, the transfer member and the spring are disposed in series in the axial direction of the discharge valve.

It is an object of the present invention to provide a pump apparatus equipped with a discharge valve capable of suppressing increase in size of the discharge valve discharge valve in an axial direction thereof.

The other objects and features of this invention will become understood from the following description with reference to the accompanying drawings.

In one aspect of the present invention, there is provided a pump apparatus including:

a discharge valve including:

a case member;

a valve body within the case member which is allowed to lift and open a fluid passage by a fluid pressure of a fluid discharged from a pump section;

a seat member having a concaved valve seat with which the valve body is brought into contact;

a retainer serving to retain the valve body on the valve seat on a side of one end of the retainer;

an elastic member disposed on a side of the other end of the retainer, the elastic member serving to apply a biasing force to the valve body in a direction toward the seat member, and

a guide portion disposed on the retainer, the guide portion serving to guide the retainer relative to the case member when the valve body is allowed to lift,

wherein the guide portion is disposed on a radial outside of the elastic member or a radial inside thereof, and the guide portion is overlapped with the elastic member in an axial direction thereof.

With the arrangement in which the elastic member and the guide portion are overlapped with each other in the axial direction of the discharge valve, the pump apparatus of the present invention can serve to reduce a size in the axial direction of the discharge valve.

In a further aspect of the present invention, there is provided a pump apparatus including:

a housing; and

a discharge valve disposed within the housing, the discharge valve including:

a case member accommodated in a valve receiving bore formed in the housing, the case member having an axial bore,

a valve body disposed within the axial bore, the valve body being allowed to lift and open a fluid passage by a fluid pressure of a fluid discharged from a pump section,

a seat member disposed within the axial bore and having a conical valve seat with which the valve body is brought into contact;

a retainer having a concaved retaining portion on a side of one end of the retainer, the concaved retaining portion serving to retain the valve body when the valve body is contacted with the valve seat,

a coil spring disposed on a side of the other end of the retainer, the coil spring biasing the valve body in a direction toward the seat member, and

a guide portion disposed on the retainer, the guide portion serving to guide the retainer with a predetermined angle relative to an axis of the axial bore when the valve body is moved to an open position and retain the valve body between the concaved retaining portion and the valve seat when the valve body is in the open position,

wherein the guide portion is disposed on a radial outside of the coil spring.

In a still further aspect of the present invention, there is provided a discharge valve for a pump apparatus, including:

a valve body that is allowed to open a fluid passage by a fluid pressure of a fluid,

a cylindrical case member having one closed end and an axial bore in which the valve body is disposed;

a seat member disposed within the axial bore, the seat member having a conical valve seat with which the valve body is brought into contact,

a retainer disposed within the axial bore so as to be moveable in an axial direction of the axial bore, the retainer having a concaved retaining portion on a side of one end thereof, the concaved retaining portion serving to retain the valve body,

a coil spring disposed in a compressed state between a side of the other end of the retainer and a bottom of the axial bore of the case member, the coil spring biasing the valve body in a direction toward the seat member, and

a guide portion disposed on the retainer, the guide portion serving to guide the retainer within the axial bore when the valve body is moved to an open position and retain the valve body between the one end of the retainer and the conical valve seat when the valve body is in the open position,

wherein the guide portion is disposed on a radial outside of the coil spring.

### BRIEF DESCRIPTION OF THE DRAWINGS

FIG. 1 is a hydraulic circuit diagram of a hydraulic brake system to which a pump apparatus according to a first embodiment of the present invention is applicable.

FIG. 2 is a schematic perspective view of a portion of the pump apparatus according to the first embodiment, showing the vicinity of a pump unit within a housing of the pump apparatus.

FIG. 3 is a sectional view of a discharge valve of the pump apparatus according to the first embodiment.

FIG. 4 is an enlarged partial sectional view of the discharge valve of the pump apparatus according to the first embodiment, showing a closed state of the discharge valve.

FIG. 5 is an enlarged partial sectional view of the discharge valve of the pump apparatus according to the first embodiment, showing an open state of the discharge valve.

FIG. 6 is an enlarged partial sectional view of the discharge valve of the pump apparatus according to a second embodiment, showing a closed state of the discharge valve.

FIG. 7 is an enlarged partial sectional view of the discharge valve of the pump apparatus according to a third embodiment, showing a closed state of the discharge valve.

### DETAILED DESCRIPTION OF THE INVENTION

### First Embodiment

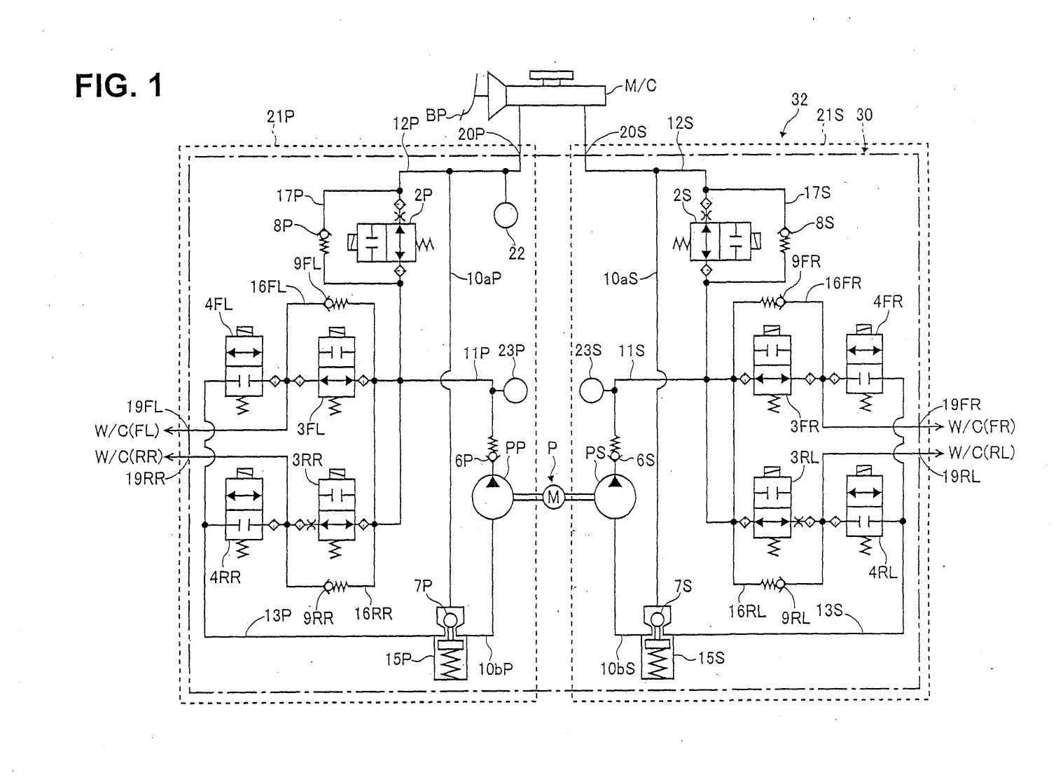

A pump apparatus according to a first embodiment of the present invention is applied to a brake system of an automobile, that is, a hydraulic brake apparatus that applies a brake fluid pressure (hydraulic pressure) to respective wheels of the automobile and thereby generates a braking force. FIG. 1 is a hydraulic circuit diagram of the hydraulic brake system. As shown in FIG. 1, the hydraulic circuit has a so-called X piping construction including two systems constituted of P system and S system. Wheel cylinder W/C(FL) for a left front wheel and wheel cylinder W/C(RR) for a right rear wheel are connected to the P system. Wheel cylinder W/C(FR) for a right front wheel and wheel cylinder W/C(RL) for a left rear wheel are connected to the S system. The brake system controls brake fluid pressure in the respective wheels independent of a braking operation of a vehicle driver, thereby executing hydraulic control in accordance with the hydraulic pressure requested in vehicle dynamics control (VDC) and anti-lock brake system (ABS) control by a controller. The brake apparatus is a so-called integral mechanical-electrical unit constituted of hydraulic control unit 30 that controls a brake fluid pressure in the respective wheels, and an electronic control unit that controls hydraulic control unit 30.

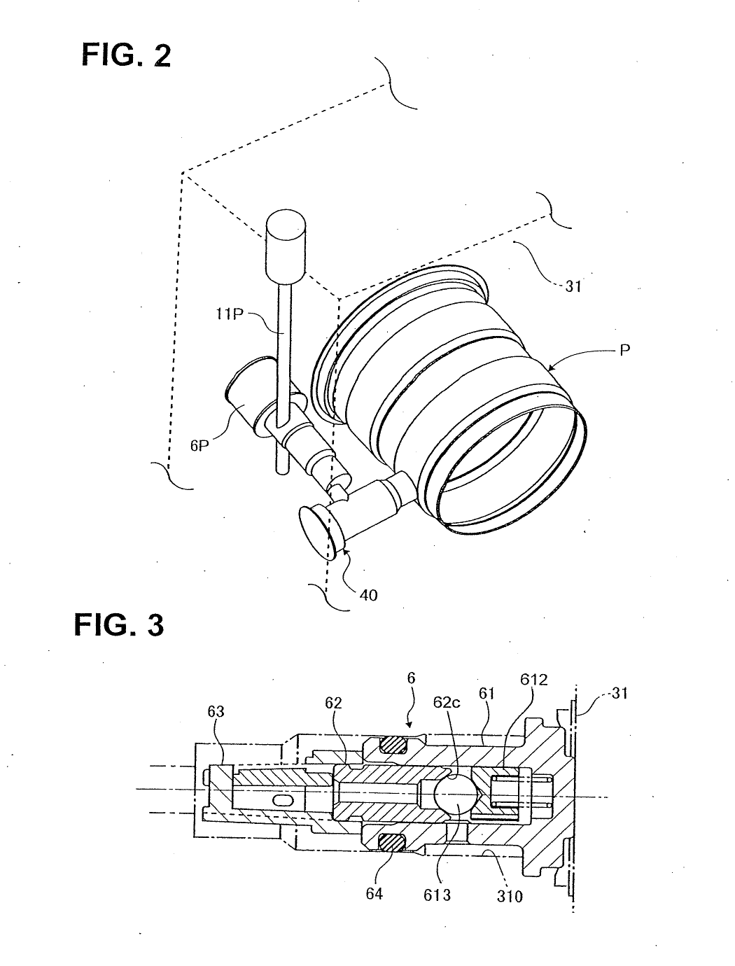

Hydraulic control unit 30 is disposed between tandem master cylinder M/C that generates fluid pressure (master cylinder pressure) in accordance with a braking operation by the vehicle driver, and wheel cylinder W/C for each of the wheels. Hydraulic control unit 30 supplies a master cylinder pressure or a control fluid pressure to each of wheel cylinders W/C. Hydraulic control unit 30 includes rotary pump unit P as a hydraulic source and a plurality of control valves (solenoid valves) which serve as hydraulic devices for generating a control fluid pressure to be supplied to each of wheel cylinders W/C. Hydraulic control unit 30 also includes housing 31 that accommodates these hydraulic devices as shown in FIG. 2. Housing 31 is a generally rectangular parallelopiped (hexahedron) shaped housing (accommodating block) made of an aluminum material. Housing 31 includes a plurality of fluid passages formed therein to thereby constitute a hydraulic circuit (brake circuit). Pump unit P and the control valves that are operated to open and close the fluid passages are disposed in the hydraulic circuit.

A constitution of the brake circuit will be explained hereinafter. The brake circuit is constituted of two systems that are P system brake circuit 21P and S system brake circuit 21S. Respective wheel cylinders W/C(FL), W/C(RR) are connected to fluid passage 11P through wheel cylinder ports 19FL, 19RR formed on an upper surface of housing 31. Respective wheel cylinders W/C(FR), W/C(RL) are connected to fluid passage 11S through wheel cylinder ports 19FR, 19RL formed on the upper surface of housing 31. Master cylinder M/C is connected to fluid passage 12P through master cylinder port 20P formed on a port connection surface of housing 31, and is connected to fluid passage 12S through master cylinder port 20S formed on the port connection surface of housing 31. Fluid passages 12P, 12S are respectively connected to fluid passages 11P, 11S, and are respectively connected to a suction side of pump unit P through fluid passages 10aP, 10bP and fluid passages 10aS. 10bS. Pressure regulating valve 7P having a function of a check valve is disposed between fluid passages 10aP, 10bP. Pressure regulating valve 7S having a function of a check valve is disposed between fluid passages 10aS, 10bS. Master cylinder pressure sensor 22 is disposed on fluid passage 12P between master cylinder port 20P and a connecting portion in which fluid passage 12P is connected with fluid passage 10aP.

Pump unit P is a tandem gear pump in which rotary gear pumps PP and PS each constituted of a pair of external gears and disposed in the P system and the S system, respectively, are driven by single motor M. A discharge side of gear pump PP and respective wheel cylinders W/C(FL), W/C(RR) are connected with each other through fluid passage 11P. A discharge side of gear pump PS and respective wheel cylinders W/C(FR), W/C(RL) are connected with each other through fluid passage 11S. Pressure increasing valves 3FL, 3RR corresponding to wheel cylinders W/C(FL), W/C(RR) are disposed on fluid passage 11P, which are a solenoid valve of a normally open type. Pressure increasing valves 3FR, 3RL corresponding to wheel cylinders W/C(FR), W/C(RL) are disposed on fluid passage 11S, which are a solenoid valve of a normally open type. Discharge valve 6P having a function of a check valve is disposed on fluid passage 11P between gear pump PP and pressure increasing valves 3FL, 3RR through damper member 40 (see FIG. 2). Discharge valve 6P allows a flow of brake fluid in a direction from gear pump PP toward pressure increasing valves 3FL, 3RR, and inhibits a flow of brake fluid in a reverse direction from pressure increasing valves 3FL, 3RR toward gear pump PP. Discharge valve 6S having a function of a check valve is disposed on fluid passage 11S between gear pump PS and pressure increasing valves 3FR, 3RL through damper member 40 (see FIG. 2). Discharge valve 6S allows a flow of brake fluid in a direction from gear pump PS toward pressure increasing valves 3FR, 3RL, and inhibits a flow of brake fluid in a reverse direction from pressure increasing valves 3FR, 3RL toward gear pump PS.

FIG. 2 is a schematic perspective view of a portion of the pump apparatus according to the first embodiment, showing the vicinity of pump unit P within housing 31. As shown in FIG. 2, damper member 40 is disposed in a radial direction of pump unit P and connected to pump unit P. Discharge valve 6P is connected to damper member 40 in a direction parallel to a rotation axis of pump unit P. Connected to discharge valve 6P is fluid passage 11P extending through housing 31 to open to the upper surface of housing 31. A construction of discharge valve 6P will be explained later.

Discharge pressure sensor 23P is disposed on fluid passage 11P between pressure increasing valves 3FL, 3RR and gear pump PP. Discharge pressure sensor 23S is disposed on fluid passage 11S between pressure increasing valves 3FR, 3RL and gear pump PS. Fluid passage 11P includes bypass passages 16FL, 16RR which bypass pressure increasing valves 3FL, 3RR, respectively. Check valves 9FL, 9RR are disposed on bypass passages 16FL, 16RR, respectively. Check valves 9FL, 9RR allow a flow of brake fluid in a direction from wheel cylinders W/C(FL), W/C(RR) toward master cylinder M/C, and inhibit a flow of brake fluid in a reverse direction from master cylinder M/C toward wheel cylinders W/C(FL), W/C(RR). Fluid passage 11S includes bypass passages 16FR, 16RL which bypass pressure increasing valves 3FR, 3RL, respectively. Check valves 9FR, 9RL are disposed on bypass passages 16FR, 16RL, respectively. Check valves 9FR, 9RL allow a flow of brake fluid in a direction from wheel cylinders W/C(FR), W/C(RL) toward master cylinder M/C, and inhibit a flow of brake fluid in a reverse direction from master cylinder M/C toward wheel cylinders W/C(FR), W/C(RL).

Master cylinder M/C is connected with fluid passages 11P, 11S through fluid passages 12P, 12S, respectively. Fluid passage 11P and fluid passage 12P are merged with each other between gear pump PP and pressure increasing valves 3FL, 3RR. Fluid passage 11S and fluid passage 12S are merged with each other between gear pump PS and pressure increasing valves 3FR, 3RL. Outflow gate valves 2P, 2S are disposed on fluid passages 12P, 12S, respectively, each being a normally open solenoid valve. Fluid passages 12P, 12S include bypass passages 17P, 17S which bypass outflow gate valves 2P, 2S, respectively. Check valves 8P, 8S are disposed on bypass passages 17P, 17S, respectively. Check valve 8P allows a flow of brake fluid in a direction from master cylinder M/C toward wheel cylinders W/C(FL), W/C(RR), and inhibits a flow of brake fluid in a reverse direction from wheel cylinders W/C(FL), W/C(RR) toward master cylinder M/C. Check valve 8S allows a flow of brake fluid in a direction from master cylinder M/C toward wheel cylinders W/C(FR), W/C(RL), and inhibits a flow of brake fluid in a reverse direction from wheel cylinders W/C(FR), W/C(RL) toward master cylinder M/C. Reservoirs 15P, 15S are disposed on the suction side of pump unit P and connected therewith through fluid passages 10bP, 10bS, respectively. Master cylinder M/C and reservoirs 15P, 15S are connected with each other through fluid passages 10aP, 10aS, respectively. Pressure regulating valve 7P is disposed on fluid passage 10aP between reservoir 15P and master cylinder M/C. Pressure regulating valve 7S is disposed on fluid passage 10aS between reservoir 15S and master cylinder M/C. Wheel cylinders W/C(FL), W/C(RR) and fluid passage 10bP are connected with each other through fluid passage 13P. Wheel cylinders W/C(FR), W/C(RL) and fluid passage 10bS are connected with each other through fluid passage 13S. Fluid passage 13P and fluid passage 10bP are merged with each other between pressure regulating valve 7P and reservoir 15P. Fluid passage 13S and fluid passage 10bS are merged with each other between pressure regulating valve 7S and reservoir 15S. Pressure reducing valves 4FL, 4RR each being a normally closed solenoid valve are disposed on fluid passage 13P. Pressure reducing valves 4FR, 4RL each being a normally closed solenoid valve are disposed on fluid passage 13S.

[Construction of Discharge Valve]

Discharge valves 6P, 6S respectively provided in the P system and the S system have the same construction, and therefore, discharge valves 6P, 6S will be collectively explained as discharge valve 6 hereinafter. FIG. 3 is a sectional view of discharge valve 6 according to the first embodiment. As shown in FIG. 3, discharge valve 6 is accommodated in valve receiving bore 310 formed in housing 31. Discharge valve 6 includes case member 61, spherical valve body 613 disposed within case member 61, seat member 62 press-fitted into case member 61, filter 63 attached to seat member 62, retainer 612 for retaining valve body 613, and coil spring 611 biasing valve body 613 toward seat member 62. Valve body 613 is allowed to lift and open the fluid passage by a fluid pressure of the fluid discharged from pump unit P. Seat member 62 has conical-shaped concaved valve seat 62c with which valve body 613 is brought into contact. Filter member 63 is disposed on a bottom side of valve receiving bore 310, and serves to remove contaminants and the like contained in the fluid discharged from pump unit P. Seal member 64 is attached to seat member 62, and serves to hermetically seal an upstream side of valve body 613 and a downstream side thereof within valve receiving bore 310.

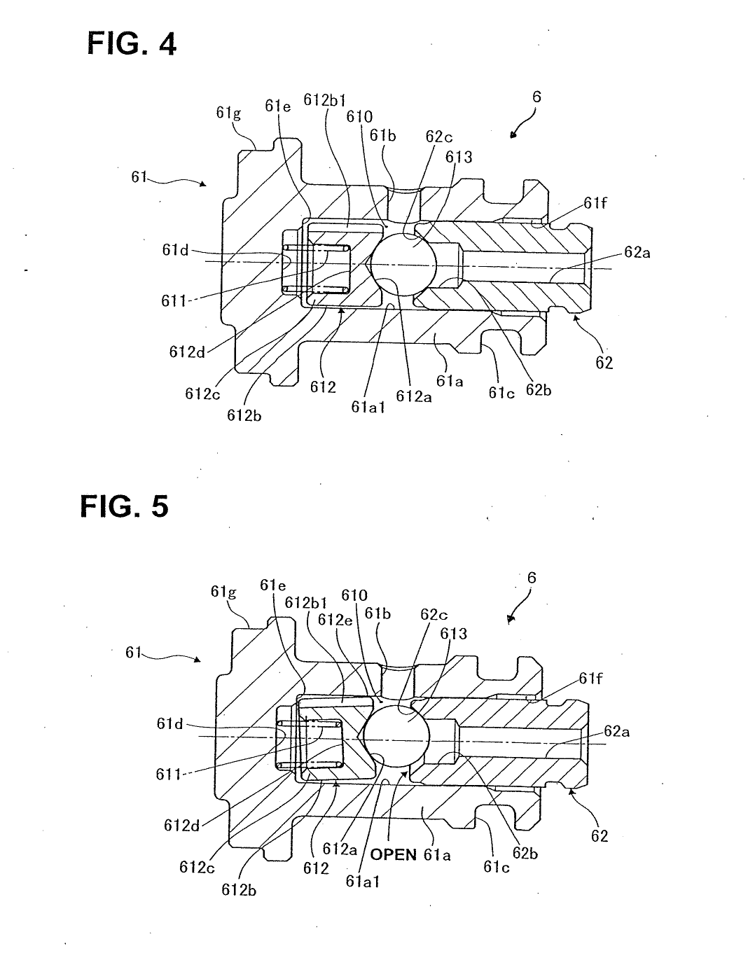

FIG. 4 is an enlarged partial sectional view of discharge valve 6 of the pump apparatus according to the first embodiment, showing a closed state of discharge valve 6. For the sake of easy understanding, filter member 63 is removed from discharge valve 6. Case member 61 has a generally cylindrical shape with one closed end which has an axial bore extending in an axial direction of case member 61. Valve body 613, seat member 62, coil spring 611 and retainer 612 are disposed within the axial bore. Case member 61 includes increased diameter portion 61g and sleeve portion 61a that extends from increased diameter portion 61g in the axial direction of case member 61. Increased diameter portion 61g is fixed to housing 31 by a suitable method such as caulking, and defines a bottom of the axial bore. Sleeve portion 61a has radial fluid passage 61b communicated with the axial bore. Radial fluid passage 61b is located at a generally middle portion of sleeve portion 61a in the axial direction of sleeve portion 61a. Radial fluid passage 61b extends from inner peripheral surface 61a1 of sleeve portion 61a in a radial direction of sleeve portion 61a, and is open to an outer peripheral surface of sleeve portion 61a.

Coil spring 611, cylindrical retainer 612 biased by coil spring 611, and valve body 613 retained by retainer 612 are accommodated within valve body receiving portion 610 of sleeve portion 61a which is defined by inner peripheral surface 61a1, inner bottom surface 61d of sleeve portion 61a and seat member 62. One end of coil spring 611 is supported on inner bottom surface 61d. Retainer 612 serves to retain valve body 613 on valve seat 62c on a side of valve body 613 (on a side of one end of retainer 612). Fluid communication between valve body receiving portion 610 and the side of pump unit P is controlled by valve body 613. Stop 61e is formed between inner peripheral surface 61a1 and inner bottom surface 61d, which has a diameter smaller than an outer diameter of retainer 612. Stop 61e is engageable with retainer 612 to thereby restrict an amount of lift of retainer 612.

A material of retainer 612 is not limited to a specific one. For instance, an iron material or a resin material may be used for retainer 612. As shown in FIG. 4, when valve body 613 is in a closing position in which valve body 613 is in contact with valve seat 62c, retainer 612 is located such that a central axis of retainer 612 is in alignment with a central axis of sleeve portion 61a of case member 61. Retainer 612 includes conically concaved retaining portion 612a formed on the side of valve body 613. A deepest portion of concaved retaining portion 612a is located in alignment with the central axis of retainer 612, i.e., substantially in alignment with the central axis of sleeve portion 61a. With this construction, when valve body 613 is held in the closing position by retainer 612, valve body 613 is biased such that a center thereof is aligned with the central axis of sleeve portion 61a. When valve body 613 is lifted, valve body 613 is also held by valve seat 62c and concaved retaining portion 612a of retainer 612 as explained in detail later.

Retainer 612 has guide portion 612b on an outer peripheral wall thereof. Guide portion 612b serves to guide retainer 612 along inner peripheral surface 61a1 of sleeve portion 61a of case member 61 when valve body 613 is allowed to lift, that is, when valve body 613 is moved to an open position as shown in FIG. 5. Guide portion 612b is configured such that there is generated a predetermined clearance between guide portion 612b and inner peripheral surface 61a1 when valve body 613 is in the closing position. Retainer 612 is slidably moveable relative to inner peripheral surface 61a1 while being kept in an inclined state relative to the central axis of sleeve portion 61a when valve body 613 is moved to the open position. Slit 612b1 is formed on a part of guide portion 612b, and extends between one end surface of retainer 612 and the other end surface thereof which are opposed to each other in an axial direction of retainer 612. Slit 612b1 serves as a communication passage allowing fluid communication between a side of valve body 613 and a side of coil spring 611 within valve body receiving portion 610, thereby serving to ensure a smooth movement of retainer 612 within valve body receiving portion 610.

Retainer 612 has a cylindrical shape having one open end, and includes cylindrical spring accommodating portion (concaved portion) 612c in which the other end portion of coil spring 611 is accommodated. Spring accommodating portion 612c is disposed on a side of coil spring 611 (on a side of the other end of retainer 612) on a radial inside of guide portion 612b. Spring accommodating portion 612c is opened to an axial end surface of retainer 612 which is opposed to inner bottom surface 61d of sleeve portion 61a. The other end of coil spring 611 is supported on a bottom of spring accommodating portion 612c. Guide portion 612b and coil spring 611 are overlapped with each other in the axial direction of retainer 612, i.e., in the axial direction of sleeve portion 61a of case member 61. Accordingly, it is possible to prevent guide portion 612b and coil spring 611 from being arranged in series in the axial direction of sleeve portion 61a of case member 61, and therefore, reduce a size of discharge valve 6 in an axial direction thereof.

An elastic force of coil spring 611 is exerted on bottom surface 612d of spring accommodating portion 612c and inner bottom surface 61d of sleeve portion 61a of case member 61. A central axis of spring accommodating portion 612c (in other words, a center of curvature of a cylindrical bored portion in which coil spring 611 is accommodated) is located offset relative to the central axis of retainer 612 (in other words, a center of curvature of cylindrical retainer 612).

Slit 612b1 is formed in an outer peripheral surface of a thickened wall portion of the outer peripheral wall of retainer 612 which has an increased thickness caused by the offset of spring accommodating portion 612c. The thickened wall portion is located on an opposite side of retainer 612 in a radial direction of retainer 612 in which spring accommodating portion 612c is offset relative to the central axis of retainer 612. With this arrangement, it is possible to ensure a sufficient strength even upon forming slit 612b1 in the outer peripheral wall of retainer 612 and thereby ensure formability. Further, slit 612b1 is formed on the side of inclination of retainer 612 which is allowed when valve body 613 is moved to the open position. With this arrangement, a clearance is generated on the side of inclination of retainer 612 so that retainer 612 can be more effectively inclined. An operation of retainer 612 with the inclination will be explained later.

Sleeve portion 61a of case member 61 has seal groove 61c in an end portion thereof located on an opposite side of increased diameter portion 61g in the axial direction of sleeve portion 61a. Seal groove 61c retains seal member 64. Sleeve portion 61a also has tapered surface 61f on the inner peripheral side of the end portion thereof. Tapered surface 61f serves as a guide upon press-fitting seat member 62 into sleeve portion 61a. Seat member 62 having a cylindrical shape is guided on inner peripheral surface 61a1 of sleeve portion 61a by tapered surface 61f, and press-fitted into the bore of sleeve portion 61a. Seat member 62 includes fluid passage 62a that is connected to the discharge side of pump unit P, and increased-diameter fluid passage 62b having a diameter larger than fluid passage 62a. Increased-diameter fluid passage 62b is open to valve seat 62c. A central axis of seat member 62 is aligned with the central axis of sleeve portion 61a (i.e., a central axis of valve body receiving portion 610). In other words, a center of curvature of seat member 62 is aligned with a center of curvature of sleeve portion 61a.

[Operation of Discharge Valve]

FIG. 5 is an enlarged partial sectional view of discharge valve 6 of the pump apparatus according to the first embodiment, showing an open state of discharge valve 6. When a discharge fluid pressure from pump unit P is supplied through fluid passage 62a of seat member 62 into sleeve portion 61a of case member 61, a force pressing valve body 613 in a leftward direction in FIG. 5 (a force acting in a direction in which valve body 613 is lifted) is generated. At this time, concaved retaining portion 612a of retainer 612 urges valve body 613 such that valve body 613 is placed at a central portion of retainer 612 in the radial direction of retain 612. However, due to the offset arrangement of the central axis of spring accommodating portion 612c relative to the central axis of retainer 612, a moment is generated in retainer 612 so that retainer 612 is upwardly inclined relative to the central axis of sleeve portion 61a as shown in FIG. 5. Then, end edge 612e of the thickened wall portion of guide portion 612b of retainer 612 is brought into contact with inner peripheral surface 61a1 of sleeve portion 61a. In this state, retainer 612 is held in the inclined state with a predetermined angle relative to the central axis of sleeve portion 61a. Owing to the inclination of retainer 612, valve body 613 is allowed to press against one side (an upper side when viewed in FIG. 5) of valve seat 62c in a radial direction of seat member 62, and is placed in the open position in which there is generated a clearance between valve body 613 and the other side of valve seat 62c. The brake fluid passing through fluid passage 62a and increased-diameter fluid passage 62b is permitted to flow into valve body receiving portion 610 and radial fluid passage 61b through the clearance.

Valve body 613 is thus placed in the opening position while being held in a state biased toward the one side of valve seat 62c as shown in FIG. 5. Therefore, it is possible to prevent valve body 613 from being oscillated in accordance with pulsation of the discharge pressure of pump unit P and therefore, enhance a sound/vibration damping ability of discharge valve 6. Further, in addition to the construction in which valve body 613 is biased toward the one side of valve seat 62c in the radial direction of seat member 62, the center (the center of curvature) of retainer 612 and the center (the center of curvature) of the cylindrical bored portion in which coil spring 611 is accommodated are offset from each other, and coil spring 611 and guide portion 612b serving for smooth movement of retainer 612 are overlapped with each other in the axial direction of retainer 612. As a result, it is possible to avoid increased size in the axial direction of discharge valve 6.

As explained above, the following functions and effects can be attained in the pump apparatus according to the first embodiment.

(1) The pump apparatus includes discharge valve 6 including case member 61, valve body 613 disposed within case member 61 and allowed to lift and open a fluid passage by a fluid pressure of a fluid discharged from pump unit (pump section) P, seat member 62 having concaved valve seat 62c with which valve body 613 is brought into contact, retainer 612 serving to retain valve body 613 on valve seat 62c on a side of one end of retainer 612, coil spring (elastic member) 611 disposed on a side of the other end of retainer 612 and serving to apply a biasing force to valve body 613 in a direction toward seat member 62, and guide portion 612b disposed on retainer 612 and serving to guide retainer 612 relative to case member 61 when valve body 613 is allowed to lift, guide portion 612b being disposed on a radial outside of coil spring 611 and overlapped with coil spring 611 in an axial direction thereof. With this construction, it is possible to avoid upsizing of discharge valve 6 in the axial direction thereof.

(2) In the pump apparatus according to the first embodiment as described in the above aspect (1), retainer 612 has a cylindrical shape, and includes cylindrical spring accommodating portion (concaved portion) 612c disposed on the side of the other end of retainer 612 on a radial inside of guide portion 612b, the spring accommodating portion 612c serving to accommodate an end portion of coil spring (elastic member) 611. Since coil spring 611 is disposed on the radial inside of guide portion 612b, a diameter of coil spring 611 can be reduced. The elastic member is not particularly limited to the coil spring of this embodiment, and may be made of a resin material or a rubber material or be a leaf spring as long as it can ensure a predetermined elastic deformation range.

(3) In the pump apparatus according to the first embodiment as described in the above aspect (2), retainer 612 includes concaved retaining portion 612a formed on a side of one end of retainer 612. Concaved retaining portion 612a serves to retain valve body 613 when valve body 613 is contacted with valve seat 62c. Valve body 613 is also retained by valve seat 62c and concaved retaining portion 612a of retainer 612 when valve body 613 is allowed to lift. With this construction, when being lifted, valve body 613 can be stably retained. As a result, it is possible to suppress vibration of valve body 613 and ensure that valve body 613 is held in the opening position.

(4) In the pump apparatus according to the first embodiment as described in the above aspect (3), guide portion 612b is disposed on the outer peripheral wall of retainer 612, and slit 612b1 as a communication passage is formed in guide portion 612b and extends between one end surface of retainer 612 and the other end surface thereof which are opposed to each other in the axial direction of retainer 612. With this construction, it is possible to prevent an inside space in valve body receiving portion 610 from being separated into two portions on opposite sides of retainer 612 in the axial direction thereof. Accordingly, retainer 612 can be moved without being restricted due to pressure pulsation that is caused in a clearance between retainer 612 and inner bottom surface 61d of sleeve portion 61a.

(5) In the pump apparatus according to the first embodiment as described in the above aspect (2), spring accommodating portion (concaved portion) 612c on the side of the other end of retainer 612 is a cylindrical bored portion, and the center of curvature of spring accommodating portion 612c is located offset relative to the center of curvature of retainer 612. With this construction, retainer 612 can be inclined relative to the central axis of sleeve portion 61a (the central axis of valve body receiving portion 610) within valve body receiving portion 610, so that valve body 613 is allowed to press against the one side of valve seat 62c in the radial direction of seat member 62 and move to the open position while being held in the pressed state. As a result, it is possible to suppress an oscillating motion of valve body 613 that is caused due to pulsation in pump discharge pressure, and therefore, enhance a sound/vibration damping ability of discharge valve 6.

(6) In the pump apparatus according to the first embodiment as described in the above aspect (2), guide portion 612b is disposed on the outer peripheral wall of retainer 612, spring accommodating portion (concaved portion) 612c on the side of the other end of retainer 612 is a cylindrical bored portion, the center of curvature of spring accommodating portion 612c is located offset relative to the center of curvature of retainer 612, and slit 612b1 is formed in the outer peripheral surface of the thickened wall portion of retainer 612 which has an increased thickness caused by offset of spring accommodating portion (concaved portion) 612c. With this construction, it is possible to ensure strength of retainer 612 upon forming slit 612b1 and ensure formability thereof. Further, there occurs a clearance between the outer peripheral surface of inclined retainer 612 and inner peripheral surface 61a1 of sleeve portion 61a in the direction of inclination of retainer 612. Therefore, it is possible to more effectively incline retainer 612 and effectively press valve body 613 against the one side of valve seat 62c in the radial direction of seat member 62 when valve body 613 is in the open position.

(7) In the pump apparatus according to the first embodiment as described in the above aspect (1), case member 61 includes stop 61e that is engageable with retainer 612 and restrict an amount of lift of retainer 612. With this construction, valve body 613 can be prevented from further lifting from the open position and moving apart from valve seat 62c in accordance with increase in flow rate of the fluid. Accordingly, valve body 613 can be always fixed to valve seat 62c, and therefore, it is possible to suppress occurrence of pressure pulsation due to swing motion of valve body 613.

(8) In the pump apparatus according to the first embodiment as described in the above aspect (1), retainer 612 is a resin molded article. Retainer 612 can be readily molded, and can be molded with high accuracy at a low cost even in a case member where the retainer has a complicated shape.

### Second Embodiment

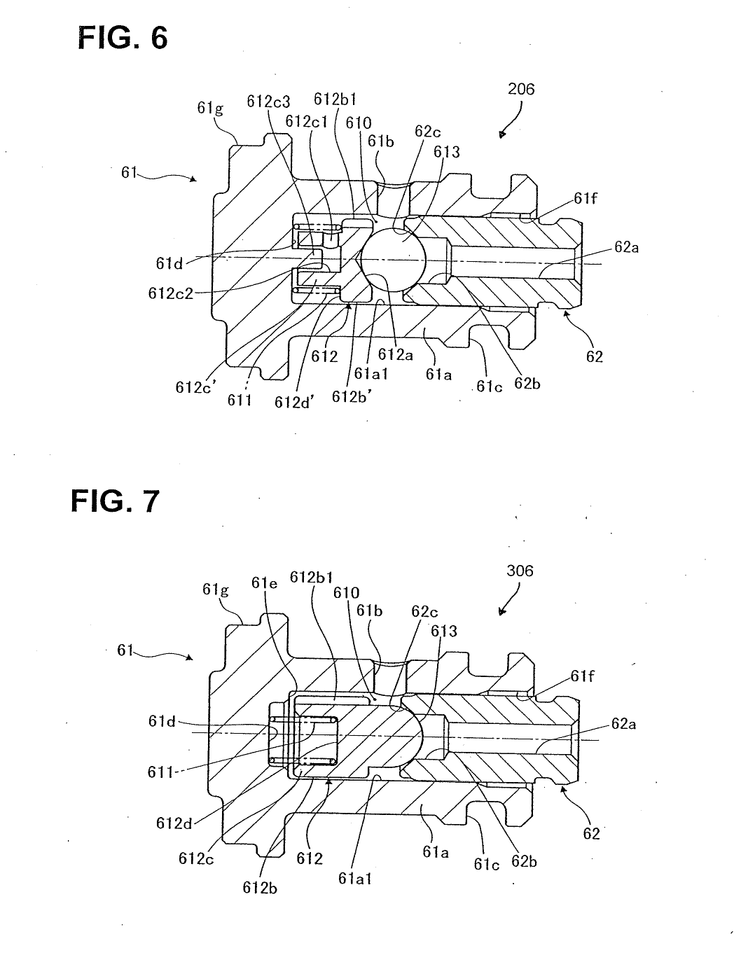

Next, the pump apparatus according to a second embodiment of the present invention will be explained hereinafter by referring to FIG. 6. The pump apparatus according to the second embodiment has the same basic construction as that of the first embodiment. Like reference numerals denote like parts, and therefore, detailed explanations therefor are omitted. FIG. 6 is an enlarged partial sectional view of discharge valve 206 of the pump apparatus according to the second embodiment, showing a closed state of discharge valve 206. In the first embodiment, when retainer 612 is slidably moved along inner peripheral surface 61a1 of sleeve portion 61a, guide portion 612b is disposed on the outer peripheral wall of retainer 612 and coil spring 611 is disposed on the radial inside of guide portion 612b. In contrast, in the second embodiment, retainer 612 includes sleeve portion 612c′ having an outer diameter smaller than that of outer peripheral wall 612b′. Sleeve portion 612c′ is disposed on the axial end surface of retainer 612 which is opposed to inner bottom surface 61d of sleeve portion 61a. Spring seat surface 612d′ is disposed on a radial outside of sleeve portion 612c′ on the axial end surface of retainer 612. Coil spring 611 is installed between spring seat surface 612d′ and inner bottom surface 61d of sleeve portion 61a of case member 61. Further, guide member 612c3 is disposed on inner bottom surface 61d. Guide member 612c3 extends from inner bottom surface 61d, and is received in a radial inside of sleeve portion 612c′. An inner peripheral surface of sleeve portion 612c′ serves as guide portion 612c2 that guides retainer 612 relative to guide member 612c3 when valve body 613 is allowed to lift. When retainer 612 is slidably moved along inner peripheral surface 61a1 of sleeve portion 61a, coil spring 611 is guided by sleeve portion 612c′, and at the same time, guide portion 612c2 is guided by guide member 612c3 so that retainer 612 can be smoothly guided. In addition, sleeve portion 612c′ includes radial fluid passage 612c1 that extends through a peripheral wall of sleeve portion 612c′ to thereby communicate the radial inside of sleeve portion 612c′ and the radial outside thereof with each other. When retainer 612 is slidably moved along inner peripheral surface 61a1 of sleeve portion 61a, radial fluid passage 612c1 allows the brake fluid to flow between the radial inside of sleeve portion 612c′ and the radial outside thereof, thereby realizing smooth movement of retainer 612.

The following functions and effects can be attained in the pump apparatus according to the second embodiment.

(1′) The pump apparatus includes discharge valve 206 including case member 61, valve body 613 disposed within case member 61 and allowed to lift and open a fluid passage by a fluid pressure of a fluid discharged from pump unit (pump section) P, seat member 62 having concaved valve seat 62c with which valve body 613 is brought into contact, retainer 612 serving to retain valve body 613 on valve seat 62c on a side of one end of retainer 612, coil spring (elastic member) 611 disposed on a side of the other end of retainer 612 and serving to apply a biasing force to valve body 613 in a direction toward seat member 62, and guide portion 612c2 disposed on retainer 612 and serving to guide retainer 612 relative to guide member 612c3 (case member 61) when valve body 613 is allowed to lift. Guide portion 612c2 is disposed on a radial inside of coil spring 611, and is overlapped with coil spring 611 in an axial direction thereof.

With this construction, it is possible to avoid upsizing of discharge valve 206 in the axial direction thereof. In addition, in the second embodiment, the center of curvature of coil spring 611 is aligned with the center of curvature of retainer 612. However, similarly to the first embodiment, the center of curvature of coil spring 611 may be located offset relative to the center of curvature of retainer 612. Further, guide portion 612c2 may have an inner diameter larger than an outer diameter of guide member 612c3 by such a predetermined amount that retainer 612 can be inclined relative to the central axis of sleeve portion 61a. In such a case member, as explained in the first embodiment, valve body 613 can be held in the state pressed against the one side of valve seat 62c of seat member 62 so that a sound/vibration damping ability of discharge valve 206 can be enhanced. Meanwhile, the constructions of the first embodiment as described in the above aspects (2) to (8) may be suitably adopted in the second embodiment so as to attain the same functions and effects.

### Third Embodiment

Next, the pump apparatus according to a third embodiment of the present invention will be explained hereinafter by referring to FIG. 7. The pump apparatus according to the third embodiment has the same basic construction as that of the first embodiment. Like reference numerals denote like parts, and therefore, detailed explanations therefor are omitted. FIG. 7 is an enlarged partial sectional view of discharge valve 306 of the pump apparatus according to the third embodiment, showing a closed state of discharge valve 306. In the first embodiment, retainer 612 and valve body 613 are formed as separate parts. In contrast, in the third embodiment, retainer 612 and valve body 613 are formed as an integral part.

The following function and effect can be attained in the pump apparatus according to the third embodiment.

(9) The pump apparatus according to the third embodiment includes discharge valve 306 including retainer 612 and valve body 613 which are formed as an integral part. With this construction, the number of parts of discharge valve 306 can be reduced.

[Other Modifications]

Other modifications of the above embodiments will be described hereinafter.

(10) A pump apparatus includes a housing and a discharge valve disposed within the housing, the discharge valve including a case member accommodated in a valve receiving bore formed in the housing, the case member having an axial bore, a valve body disposed within the axial bore and allowed to lift and open a fluid passage by a fluid pressure of a fluid discharged from a pump section, a seat member disposed within the axial bore and having a conical valve seat with which the valve body is brought into contact, a retainer having a concaved retaining portion on a side of one end of the retainer, the concaved retaining portion serving to retain the valve body when the valve body is contacted with the valve seat, a coil spring disposed on a side of the other end of the retainer, the coil spring biasing the valve body in a direction toward the seat member, and a guide portion formed in the retainer, the guide portion serving to guide the retainer with a predetermined angle relative to an axis of the axial bore when the valve body is moved to an open position and retain the valve body between the concaved retaining portion and the valve seat when the valve body is in the open position, wherein the guide portion is disposed on a radial outside of the coil spring. With this construction, it is possible to avoid upsizing of the discharge valve in the axial direction thereof.

(11) In the pump apparatus as described in the above modification (10), the retainer has a cylindrical shape, and includes a concaved portion formed on a radial inside of the guide portion on the side of the other end of the retainer, the concaved portion serving to accommodate an end portion of the coil spring. Since the coil spring is disposed on a radial inside of the guide portion, a diameter of the coil spring can be reduced.

(12) In the pump apparatus as described in the above modification (10), the guide portion is disposed on an outer peripheral wall of the retainer, and includes a communication passage extending between one end surface of the retainer and the other end surface thereof which are opposed to each other in an axial direction of the retainer. With this construction, when the retainer is slidably moved in the axial bore, the brake fluid can flow between the side of the one end of the retainer and the side of the other end thereof through the communication passage so that resistance to a slide movement of the retainer can be reduced.

(13) In the pump apparatus as described in the above modification (11), the concaved portion formed on the side of the other end of the retainer is a cylindrical bored portion, and a center of curvature of the cylindrical bored portion is located offset relative to a center of curvature of the retainer.

(14) In the pump apparatus as described in the above modification (13), the guide portion is disposed on an outer peripheral wall of the retainer, and includes a communication passage extending between one end surface of the retainer and the other end surface thereof which are opposed to each other in an axial direction of the retainer, the communication passage being formed in a thickened wall portion of the outer peripheral wall of the retainer which has an increased thickness caused by offset of the cylindrical bored portion. With this construction, when the communication passage is formed, strength of the retainer can be ensured and formability thereof can be ensured. Further, a clearance is generated on the side of inclination of the retainer, so that the retainer can be more effectively inclined and the valve body can be effectively pressed against the one side of the valve seat in the open position.

(15) In the pump apparatus as described in the above modification (10), a stop is disposed in the axial bore of the case member, and is engageable with the retainer to thereby restrict an amount of lift of the retainer. With this construction, the valve body can be prevented from further lifting from the open position in which the valve body is pressed against the one side of the valve seat, and moving apart from the valve seat in accordance with increase in flow rate of the fluid. Accordingly, it is possible to suppress occurrence of pressure pulsation due to swing motion of the valve body.

(16) A discharge valve for a pump apparatus includes a valve body that is allowed to open a fluid passage by a fluid pressure of a fluid, a cylindrical case member having one closed end and an axial bore in which the valve body is disposed, a seat member disposed within the axial bore, the seat member having a conical valve seat with which the valve body is brought into contact, a retainer disposed within the axial bore so as to be moveable in an axial direction of the axial bore, the retainer having a concaved retaining portion on a side of one end thereof, the concaved retaining portion serving to retain the valve body, a coil spring disposed in a compressed state between a side of the other end of the retainer and a bottom of the axial bore of the case member, the coil spring biasing the valve body in a direction toward the seat member, and a guide portion disposed on the retainer, the guide portion serving to guide the retainer within the axial bore when the valve body is moved to an open position and retain the valve body between the one end of the retainer and the conical valve seat when the valve body is in the open position, wherein the guide portion is disposed on a radial outside of the coil spring. With this construction, it is possible to avoid upsizing of the discharge valve in the axial direction thereof.

(17) In the discharge valve for a pump apparatus as described in the above modification (16), when the valve body is in the open position, the valve body is retained between the concaved retaining portion and the valve seat. With this construction, when the valve body is allowed to lift, the valve body can be stably retained in the open position so that vibration of the valve body can be suppressed, and the open state of the valve body can be ensured.

(18) In the discharge valve for a pump apparatus as described in the above modification (17), the retainer has a cylindrical shape, and includes a cylindrical bored portion disposed on the side of the other end of the retainer on a radial inside of the guide portion, the cylindrical bored portion serving to accommodate an end portion of the coil spring, wherein a center of curvature of the cylindrical bored portion is located offset relative to a center of curvature of the retainer. That is, the coil spring is disposed on the radial inside of the guide portion. Therefore, a radial size of the coil spring can be reduced.

(19) In the discharge valve for a pump apparatus as described in the above modification (18), the guide portion is disposed on an outer peripheral wall of the retainer, and includes a communication passage extending between one end surface of the retainer and the other end surface thereof which are opposed to each other in an axial direction of the retainer, the communication passage being formed in a thickened wall portion of the outer peripheral wall of the retainer which has an increased thickness caused by offset of the cylindrical bored portion. With this construction, when the communication passage is formed, strength of the retainer can be ensured and formability thereof can be ensured. Further, a clearance is generated on the side of inclination of the retainer, so that the retainer can be more effectively inclined and the valve body can be effectively pressed against the one side of the valve seat in the open position.

(20) In the discharge valve for a pump apparatus as described in the above modification (19), a stop is disposed on a bottom side of the axial bore of the case member, the stop being engageable with the other end of the retainer to thereby restrict an amount of lift of the retainer. With this construction, the valve body can be prevented from further lifting from the open position in which the valve body is pressed against the one side of the valve seat, and moving apart from the valve seat in accordance with increase in flow rate of the fluid. Accordingly, it is possible to suppress occurrence of pressure pulsation due to swing motion of the valve body.

This application is based on a prior Japanese Patent Application No. 2012-203811 filed on Sep. 18, 2012. The entire contents of the Japanese Patent Application No. 2012-203811 are hereby incorporated by reference.

Although the invention has been described above by reference to certain embodiments of the invention and modifications thereof, the invention is not limited to the embodiments and modifications as described above. Variations of the embodiments and modifications as described above will occur to those skilled in the art in light of the above teachings. The scope of the invention is defined with reference to the following claims.

What is claimed is:

1. A pump apparatus comprising:
a discharge valve comprising:
a case member;
a valve body within the case member 61 which is allowed to lift and open a fluid passage by a fluid pressure of a fluid discharged from a pump section;
a seat member having a concaved valve seat with which the valve body is brought into contact;
a retainer serving to retain the valve body on the valve seat on a side of one end of the retainer;
an elastic member disposed on a side of the other end of the retainer, the elastic member serving to apply a biasing force to the valve body in a direction toward the seat member, and
a guide portion disposed on the retainer, the guide portion serving to guide the retainer relative to the case member when the valve body is allowed to lift,
wherein the guide portion is disposed on a radial outside of the elastic member or a radial inside thereof, and the guide portion is overlapped with the elastic member in an axial direction thereof.

2. The pump apparatus as claimed in claim 1, wherein the retainer has a cylindrical shape and includes a concaved portion disposed on the side of the other end of the retainer on a radial inside of the guide portion, the concaved portion serving to accommodate an end portion of elastic member.

3. The pump apparatus as claimed in claim 2, wherein the retainer comprises a concaved retaining portion formed on the side of one end of the retainer, the concaved retaining portion serving to retain the valve body when the valve body is contacted with the valve seat, wherein the valve body is retained by the valve seat and the concaved retaining portion of the retainer when the valve body is allowed to lift.

4. The pump apparatus as claimed in claim 3, wherein the guide portion is disposed on an outer peripheral wall of the retainer, and the guide portion comprises a slit that extends between one end surface of the retainer and the other end surface thereof which are opposed to each other in an axial direction of the retainer.

5. The pump apparatus as claimed in claim 2, wherein the concaved portion on the side of the other end of the retainer is a cylindrical bored portion, and a center of curvature of the concaved portion is located offset relative to a center of curvature of the retainer.

6. The brake apparatus as claimed in claim 2, wherein the guide portion is disposed on an outer peripheral wall of the retainer, and the retainer comprises a spring accommodating portion on the side of the other end of the retainer which is a cylindrical bored portion, wherein a center of curvature of the spring accommodating portion is located offset relative to a center of curvature of the retainer, and the slit is formed in an outer peripheral surface of a thickened wall portion of the retainer which has the increased thickness caused by offset of the spring accommodating portion.

7. The pump apparatus as claimed in claim 1, wherein the case member comprises a stop that is engageable with the retainer and restricts an amount of lift of the retainer.

8. The pump apparatus as claimed in claim 1, wherein the retainer is a resin molded article.

9. The pump apparatus as claimed in claim 1, wherein the retainer and the valve body are formed as an integral part.

10. A pump apparatus comprising:
a housing; and
a discharge valve disposed within the housing, the discharge valve comprising:
a case member accommodated in a valve receiving bore formed in the housing, the case member having an axial bore,
a valve body disposed within the axial bore, the valve body being allowed to lift and open a fluid passage by a fluid pressure of a fluid discharged from a pump section,
a seat member disposed within the axial bore and having a conical valve seat with which the valve body is brought into contact;
a retainer having a concaved retaining portion on a side of one end of the retainer, the concaved retaining portion serving to retain the valve body when the valve body is contacted with the valve seat,
a coil spring disposed on a side of the other end of the retainer, the coil spring biasing the valve body in a direction toward the seat member, and
a guide portion disposed on the retainer, the guide portion serving to guide the retainer with a predetermined angle relative to an axis of the axial bore when the valve body is moved to an open position and retain the valve body between the concaved retaining portion and the valve seat when the valve body is in the open position,
wherein the guide portion is disposed on a radial outside of the coil spring.

11. The pump apparatus as claimed in claim 10, wherein the retainer has a cylindrical shape, the retainer comprising a concaved portion formed on a radial inside of the guide portion on the side of the other end of the retainer, the concaved portion serving to accommodate an end portion of the coil spring.

12. The pump apparatus as claimed in claim 10, wherein the guide portion is disposed on an outer peripheral wall of the retainer, the guide portion comprising a communication passage extending between one end surface of the retainer and the other end surface thereof which are opposed to each other in an axial direction of the retainer.

13. The pump apparatus as claimed in claim 11, wherein the concaved portion formed on the side of the other end of the retainer is a cylindrical bored portion, and a center of curvature of the cylindrical bored portion is located offset relative to a center of curvature of the retainer.

14. The pump apparatus as claimed in claim 13, wherein the guide portion is disposed on an outer peripheral wall of the retainer, the guide portion comprising a communication passage extending between one end surface of the retainer and the other end surface thereof which are opposed to each other in an axial direction of the retainer, the communication passage being formed in a thickened wall portion of the outer peripheral wall of the retainer which has an increased thickness caused by offset of the cylindrical bored portion.

15. The pump apparatus as claimed in claim 10, wherein a stop is disposed in the axial bore of the case member, the stop being engageable with the retainer to thereby restrict an amount of lift of the retainer.

16. A discharge valve for a pump apparatus, comprising:
a valve body that is allowed to open a fluid passage by a fluid pressure of a fluid,
a cylindrical case member having one closed end and an axial bore in which the valve body is disposed;
a seat member disposed within the axial bore, the seat member having a conical valve seat with which the valve body is brought into contact,
a retainer disposed within the axial bore so as to be moveable in an axial direction of the axial bore, the retainer having a concaved retaining portion on a side of one end thereof, the concaved retaining portion serving to retain the valve body,
a coil spring disposed in a compressed state between a side of the other end of the retainer and a bottom of the axial bore of the case member, the coil spring biasing the valve body in a direction toward the seat member, and
a guide portion disposed on the retainer, the guide portion serving to guide the retainer within the axial bore when the valve body is moved to an open position and retain the valve body between the one end of the retainer and the conical valve seat when the valve body is in the open position,
wherein the guide portion is disposed on a radial outside of the coil spring.

17. The discharge valve for a pump apparatus as claimed in claim 16, wherein when the valve body is in the open position, the valve body is retained between the concaved retaining portion and the valve seat.

18. The discharge valve for a pump apparatus as claimed in claim 17, wherein the retainer has a cylindrical shape, the retainer comprising a cylindrical bored portion disposed on the side of the other end of the retainer on a radial inside of the guide portion, the cylindrical bored portion serving to accommodate an end portion of the coil spring, wherein a center of curvature of the cylindrical bored portion is located offset relative to a center of curvature of the retainer.

19. The discharge valve for a pump apparatus as claimed in claim 18, wherein the guide portion is disposed on an outer peripheral wall of the retainer, the guide portion comprising a communication passage extending between one end surface of the retainer and the other end surface thereof which are opposed to each other in an axial direction of the retainer, the communication passage being formed in a thickened wall portion of the outer peripheral wall of the retainer which has an increased thickness caused by offset of the cylindrical bored portion.

20. The discharge valve for a pump apparatus as claimed in claim 18, further comprising a stop disposed on a bottom side of the axial bore of the case member, the stop being engageable with the other end of the retainer to thereby restrict an amount of lift of the retainer.
